(19) United States
(12) Patent Application Publication
(10) Pub. No.: US 2018/0244911 A1
(43) Pub. Date: Aug. 30, 2018

(54) COMPOSITION, CONTACT LENS COATING AGENT, METHOD FOR PRODUCING CONTACT LENS, AND CONTACT LENS

(71) Applicants: JSR CORPORATION, Minato-ku (JP); JSR LIFE SCIENCES CORPORATION, Minato-ku (JP)

(72) Inventors: Kazuhiro ISO, Minato-ku (JP); Satoshi HYUUGAJI, Minato-ku (JP)

(73) Assignees: JSR CORPORATION, Minato-ku (JP); JSR LIFE SCIENCES CORPORATION, Minato-ku (JP)

(21) Appl. No.: 15/757,565

(22) PCT Filed: Sep. 7, 2016
(86) PCT No.: PCT/JP2016/076235

§ 371 Date: Mar. 5, 2018

(30) Foreign Application Priority Data
Sep. 7, 2015 (JP) 2015-175642

(51) Int. Cl. C08L 33/26; C08L 43/02; C08L 83/08; C11D 3/37; G02B 1/04; G02B 1/18

(52) U.S. Cl. CPC C08L 33/26; C08L 43/02; C08L 83/08; C08L 2203/02; C11D 3/373; G02B 1/043; G02B 1/18; C11D 3/3719

(57) ABSTRACT

The present invention relates to: a composition; a contact lens coating agent; a method of producing a contact lens; and a contact lens. The composition contains: a polymer which includes a repeating unit (A) having an HLB value of 14 or higher and a repeating unit (B) having an HLB value of 1 to less than 14; and a cationic group-containing bactericidal compound.

### TECHNICAL FIELD

The present invention relates to a composition, a contact lens coating agent, a method of producing a contact lens, and a contact lens.

### BACKGROUND ART

Ophthalmic compositions (e.g., contact lens cleaning solutions (contact lens washing liquids), contact lens solutions (contact lens storage liquids), and eye drops (drugs)), cleaning or cosmetic compositions that are used for washing and treating human skin, scalp, hair and the like, medicines and quasi drugs are required to exhibit low irritation (e.g., by low cytotoxicity) and be highly safe while having a bactericidal action and, with regard to contact lens cleaning solutions and the like, it is further required to remove lipid stains and inhibit lipid adhesion.

For instance, contact lenses are roughly classified into hydrous contact lenses (including soft contact lenses) and non-hydrous contact lenses (including hard contact lenses and soft contact lenses), and hydrous contact lenses generally have an advantage of giving more favorable feeling of wearing than non-hydrous contact lenses. However, since conventional hydrous contact lenses have a high water content, there are such problems that the lenses dry up quickly and the oxygen permeability is reduced.

Accordingly, silicone hydrogel contact lenses which have a low water content and a high oxygen permeability have been developed, and these contact lenses have been mainly used in recent years. However, silicone hydrogels have a problem in that the silicone chains contained therein show hydrophobicity and lipid stains thus easily adhere thereto. When a contact lens is continuously used while leaving such lipid stains, there are risks of causing cloudiness of the lens, a reduction in the vision correction power, and an adverse effect on the cornea. Therefore, it is an important issue to remove lipid stains adhered to the lens surface and to inhibit adhesion of lipid stains by a lens hydrophilization treatment or the like.

Bactericidal compounds are used in eye drops, contact lens cleaning solutions and contact lens solutions. As the bactericidal compounds, particularly, cationic group-containing disinfectants such as benzalkonium chloride are widely used because of their excellent bactericidal activities.

However, these bactericidal compounds have a high affinity for contact lenses, particularly soft contact lenses; therefore, when a contact lens is treated with a cleaning solution or storage liquid that contains such a bactericidal compound or when an eye drop containing such a bactericidal compound is used while wearing a contact lens, the compound sometimes adsorbs to the contact lens and is accumulated in the contact lens over time. Such adsorption or accumulation may cause deterioration and physical change in the contact lens, and the long-term wearing of such a contact lens with a bactericidal compound being accumulated thereon potentially induces ophthalmopathy such as corneal staining.

Conventionally, various contact lens cleaning agents have been proposed for the purpose of inhibiting ophthalmopathy such as corneal staining. For example, it has been proposed to incorporate a carboxylic acid-modified polyvinyl alcohol or a sulfonic acid-modified polyvinyl alcohol into a cleaning solution or a storage liquid (Patent Document 1).

Moreover, benzalkonium chloride and the like have been used as disinfectants or antiseptic agents in the healthcare and hygiene-related fields; however, these compounds have a problem of being highly irritative to the skin and the ocular mucosa. A reduction in the amount of such a compound for the purpose of suppressing the irritation makes the bactericidal effect insufficient in some cases, while an attempt of attaining a sufficient bactericidal effect makes the irritation stronger, which presents a safety problem.

### RELATED ART DOCUMENT

### Patent Document

[Patent Document 1] JP 2002-128615 A

### SUMMARY OF THE INVENTION

### Problems to be Solved by the Invention

In the polymer described in Patent Document 1, it is speculated that a carboxy group or a sulfo group interacts with a cationic group of a bactericidal compound and adsorption of the bactericidal compound to a lens, which causes corneal staining, is thereby inhibited; however, the effect of inhibiting adsorption of the bactericidal compound to a contact lens cannot be considered sufficient, and there is a room for improvement in terms of safety.

Further, in the application of benzalkonium chloride and the like to the skin, ocular mucosa and the like for sterilization or disinfection, there is a room for improvement in safety without reducing the bactericidal action.

One embodiment of the present invention provides a composition which is not likely to deteriorate the bactericidal properties of a bactericidal compound and has excellent safety and properties of removing lipid stains and inhibiting lipid adhesion.

### Technical Solution

One embodiment of the present invention provides: a composition (hereinafter, also referred to as “the present composition”) comprising a polymer which comprises a repeating unit (A) having an HLB value of 14 or higher and a repeating unit (B) having an HLB value of 1 to less than 14 (hereinafter, also referred to as “the present polymer”); and a cationic group-containing bactericidal compound.

Another embodiment of the present invention provides: a contact lens coating agent comprising the present polymer (hereinafter, also referred to as “the present coating agent”); a method of producing a contact lens, the method comprising the step of coating the present polymer on at least apart of a surface of a contact lens; and a contact lens comprising the present polymer on at least a part of a surface thereof (hereinafter, also referred to as “the present contact lens”).

### Advantageous Effects of the Invention

According to the present invention, a composition which exhibits excellent properties of removing lipid stains and inhibiting lipid adhesion and is extremely safe because of its low cytotoxicity and the like while maintaining a bactericidal action provided by a cationic group-containing bactericidal compound can be provided.

Specifically, an ophthalmic composition, a cleaning composition, a cosmetic composition, a medical composition and a quasi drug composition which has a low cytotoxicity caused by a cationic group-containing bactericidal compound and exhibits excellent suppression of irritation while maintaining a bactericidal action provided by the bactericidal compound can be provided.

Further, an ophthalmic composition, particularly a contact lens cleaning solution, a contact lens solution, a contact lens fitting liquid, an eye wash, and an eye drop, which exhibit excellent properties of removing lipid stains and inhibiting lipid adhesion and have a low cytotoxicity caused by a cationic group-containing bactericidal compound and a low adsorptivity of the bactericidal compound to contact lenses as well as excellent storage stability while maintaining a bactericidal action provided by the bactericidal compound, can be provided. Accordingly, the use of such an ophthalmic composition is unlikely to induce ophthalmopathy such as corneal staining.

Moreover, the present coating agent and the present contact lens not only exhibit excellent effects in terms of the ability to inhibit adsorption of a cationic group-containing bactericidal compound and the ability to inhibit lipid adsorption, but also have excellent sustainability of these effects.

### Mode for Carrying Out the Invention

### <Polymer>

The present composition and the present coating agent comprise the present polymer, and the present contact lens comprises the present polymer on at least a part of a surface thereof. First, the present polymer will be described in detail.

Since the present composition comprises the present polymer along with a bactericidal compound, the present composition not only exhibits excellent properties of removing lipid stains and inhibiting lipid adhesion but also is extremely safe and has a low cytotoxicity caused by the bactericidal compound while maintaining a bactericidal action provided by the bactericidal compound; therefore, the present composition can be particularly suitably used as a bactericidal composition, especially as an ophthalmic composition, a cleaning composition, a cosmetic composition, a medical composition, or a quasi drug composition.

Further, the present composition has a low cytotoxicity caused by the bactericidal compound, and the bactericidal compound exhibits low adsorption to contact lenses. Therefore, the present composition exerts effects that it is unlikely to cause deterioration or physical change of a contact lens and to induce ophthalmopathy such as corneal staining, while maintaining bactericidal properties that are required for eye drops as well as for cleaning solutions and storage liquids of contact lenses.

The present coating agent and the present contact lens also comprise the present polymer and, therefore, not only exhibit excellent effects in terms of the ability of inhibiting adsorption of the bactericidal compound and the ability of inhibiting lipid adsorption, but also have excellent sustainability of these effects. Accordingly, a contact lens that is unlikely to cause ophthalmopathy such as corneal staining can be obtained.

The reason why the present invention exerts such effects is not necessarily clear; however, it is believed that the repeating unit (B) contained in the present polymer acts on a contact lens or the like (e.g., adsorption to a contact lens) to remove lipid stains and the surface of the contact lens or the like is hydrophilically modified by the repeating unit (A), as a result of which the adsorptivity of the bactericidal compound and lipid stains to the contact lens or the like is reduced.

### [Repeating Unit (A)]

The present polymer comprises a repeating unit (A) having an HLB value of 14 or higher. The repeating unit (A) is not particularly restricted as long as its HLB value is in the above-described range; however, the repeating unit (A) is preferably a hydrophilic repeating unit.

The present polymer may have one, or two or more repeating units corresponding to the repeating unit (A).

The term “hydrophilic” used herein means that the repeating unit has a strong affinity for water. Specifically, when a homopolymer consisting of only one type of repeating unit (which homopolymer has a number-average molecular weight of about 10,000 as determined by the measurement method described in the section of Examples) dissolves in an amount of 1 g or greater with respect to 100 g of pure water at normal temperature (25° C.), the repeating unit is regarded as hydrophilic.

The HLB (Hydrophile-Lipophile Balance) value of the repeating unit (A) is 14 or higher, preferably 17 or higher. When the HLB value is less than 14, the effect of inhibiting adhesion of the bactericidal compound and lipids maybe insufficient, and the effect of imparting hydrophilicity to the contact lens surface may also be insufficient.

The HLB value of a repeating unit means a value calculated from the ratio of the organic factor and the inorganic factor of a compound (Oda method) and can be determined by the calculation method described in “Formulation Design with Organic Conception Diagram” [1998, Nihon Emulsion Co., Ltd.].

The repeating unit (A) preferably contains a structural unit represented by the following Formula (1):

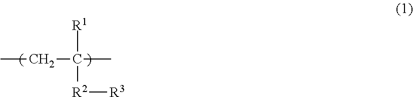

[wherein, R¹ represents a hydrogen atom or a methyl group; R² represents —O—, *-(C═O)—O—, *-(C═O)—NR⁴—, or *-NR⁴—(C═O)—(R⁴ represents a hydrogen atom or an organic group having 1 to 10 carbon atoms, and * represents a position at which the group is bound to the carbon atom bound with R¹ in the Formula (1)); and R³ represents an organic group having 1 to 100 carbon atoms,

with a proviso that, when R² is *-(C═O)—NR⁴— or *-NR⁴—(C═O)—, R³ and R⁴ are optionally bound together to form a ring].

When R³ and R⁴ are bound together and form a ring, the repeating unit is not particularly restricted, and examples thereof include repeating units represented by the following Formulae (A5) and (A6).

It is further preferred that the repeating unit (A) contain at least one repeating unit selected from a repeating unit (A1) represented by the below-described Formula (A1), a repeating unit (A2) represented by the below-described Formula (A2), a repeating unit (A3) represented by the below-described Formula (A3), a repeating unit (A4) represented by the below-described Formula (A4), a repeating unit (A5) represented by the below-described Formula (A5), and a repeating unit (A6) represented by the below-described Formula (A6).

Thereamong, the repeating units represented by Formulae (A2) to (A6) are preferred, and the repeating units represented by Formula (A2) or Formulae (A4) to (A6) are more preferred. The repeating units represented by Formulae (A4) to (A6) are preferred from the standpoints of, for example, obtaining a composition and a coating agent that are not easily hydrolyzed and have excellent storage stability.

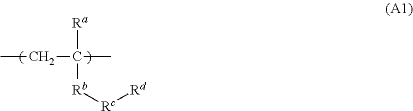

[wherein, R^{a} represents a hydrogen atom or a methyl group; R^{b} represents —O—, *-(C═O)—O—, *-(C═O)—NR^{e}—, or *-NR^{e}—(C═O)—(R^{e} represents a hydrogen atom or an organic group having 1 to 10 carbon atoms, and * represents a position at which the group is bound to the carbon atom bound with R^{a} in the Formula (A1)); R^{c} represents a polyoxyalkylene group; and R^{d} represents a hydrogen atom or an alkyl group having 1 to 15 carbon atoms,

with a proviso that a total number of carbon atoms of R^{c} and R^{d} is 100 or less]

R^{b} is preferably *-(C═O)—O—.

R^{e} is preferably a hydrogen atom or an alkyl group having 1 to 5 carbon atoms. This alkyl group may be linear or branched, and examples thereof include a methyl group, an ethyl group, an n-propyl group, and an isopropyl group.

R^{c} is preferably a group represented by —(R^{f}O)ₚ—. R^{f} is an alkylene group having 2 to 6 carbon atoms, preferably an alkylene group having 2 to 4 carbon atoms. This alkylene group may be linear or branched, and examples thereof include an ethylene group, a trimethylene group, a propylene group, and a tetramethylene group. It is noted here that p R^{f}s may be the same or different. Further, p represents 2 to 100 as an average value.

The alkyl group having 1 to 15 carbon atoms represented by R^{d} may be linear or branched, and examples thereof include a methyl group, an ethyl group, an n-propyl group, an isopropyl group, an n-butyl group, an isobutyl group, a sec-butyl group, a tert-butyl group, a 2-ethylhexyl group, an octyl group, a decyl group, and a lauryl group.

The plural R^{a}s contained in the repeating unit may be the same or different. Hereinafter, for other symbols used in each structural unit as well, plural groups represented by the same symbol contained in a repeating unit may be the same or different.

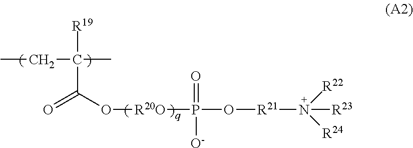

[wherein, R¹⁹ represents a hydrogen atom or a methyl group; R²⁰ represents an alkylene group having 2 to 4; R²¹ represents an alkylene group having 1 to 10 carbon atoms; R²², R²³ and R²⁴ each independently represent a hydrogen atom or a hydrocarbon group having 1 to 8 carbon atoms; and q represents 1 to 10 as an average value]

The alkylene group having 2 to 4 represented by R²⁰ may be linear or branched, and examples thereof include an ethylene group, a trimethylene group, a propylene group, and a tetramethylene group. When there are plural R²⁰s, the plural R²⁰s may be the same or different.

The number of carbon atoms of the alkylene group having 1 to 10 carbon atoms represented by R²¹ is preferably 2 to 8, more preferably 2 to 6. This alkylene group may be linear or branched, and examples thereof include a methylene group, an ethylene group, a trimethylene group, a propylene group, and a tetramethylene group.

R²², R²³ and R²⁴ are each preferably an alkyl group having 1 to 8 carbon atoms. The number of carbon atoms of the alkyl group is preferably 1 to 6, more preferably 1 to 4. Further, the alkyl group may be linear or branched, and examples thereof include a methyl group, an ethyl group, an n-propyl group, an isopropyl group, an n-butyl group, an isobutyl group, a sec-butyl group, and a tert-butyl group.

Further, q is preferably 1 to 8, more preferably 1 to 6, as an average value.

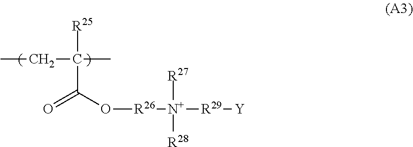

[wherein, Y represents —(C═O)O⁻, —(O═S═O)O⁻, —O(O═S═O)O⁻, —(S═O)O⁻, —O(S═O)O⁻, —OP(═O)(OR³⁰)O⁻, —OP(═O)(R³⁰)O⁻, —P(═O)(OR³⁰)O⁻, or —P(═O)(R³⁰)O⁻ (R³⁰ represents an alkyl group having 1 to 3 carbon atoms); R²⁵ represents a hydrogen atom or a methyl group; R²⁶ represents a divalent organic group having 1 to 10 carbon atoms; R²⁷ and R²⁸ each independently represent a hydrocarbon group having 1 to 10 carbon atoms; and R²⁹ represents a divalent organic group having 1 to 10 carbon atoms]

Y is preferably —(C═O)O⁻.

The alkyl group having 1 to 3 carbon atoms represented by R³⁰ may be linear or branched, and examples thereof include a methyl group, an ethyl group, an n-propyl group, and an isopropyl group.

The divalent organic groups having 1 to 10 carbon atoms represented by R²⁶ and R²⁹ are each preferably a divalent aliphatic hydrocarbon group, more preferably an alkylene group. The number of carbon atoms of the alkylene group is preferably 1 to 8, more preferably 1 to 6. The alkylene group may be linear or branched, and examples thereof include a methylene group, an ethylene group, a trimethylene group, a propylene group, a tetramethylene group, a pentamethylene group, and a hexamethylene group.

The number of carbon atoms of the hydrocarbon groups having 1 to 10 carbon atoms represented by R²⁷ and R²⁸ is preferably 1 to 6, more preferably 1 to 4. The hydrocarbon groups are preferably alkyl groups and may be linear or branched, and examples thereof include a methyl group, an ethyl group, an n-propyl group, an isopropyl group, an n-butyl group, an isobutyl group, a sec-butyl group, and a tert-butyl group.

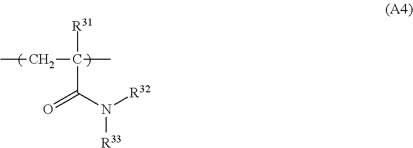

[wherein, R³¹ represents a hydrogen atom or a methyl group; R³² and R³³ each independently represent a hydrogen atom, an alkyl group having 1 to 6 carbon atoms, or a hydroxyalkyl group having 1 to 6 carbon atoms]

The number of carbon atoms of the alkyl groups having 1 to 6 carbon atoms represented by R³² and R³³ is preferably 1 to 3, and the number of carbon atoms of the hydroxyalkyl groups represented by R³² and R³³ is preferably 1 to 4. The alkyl groups in these groups may be linear or branched. Further, the position of the substitution with a hydroxy group contained in the hydroxyalkyl groups is not particularly restricted. Examples of such an alkyl group include a methyl group, an ethyl group, an n-propyl group, an isopropyl group, an n-butyl group, an isobutyl group, a sec-butyl group, and a tert-butyl group. Examples of the hydroxyalkyl group include a hydroxymethyl group, a hydroxyethyl group, a hydroxypropyl group, and a hydroxybutyl group.

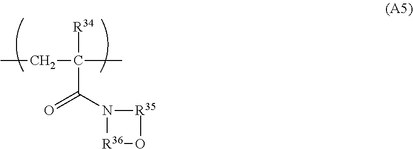

[wherein, R³⁴ represents a hydrogen atom or a methyl group; and R³⁵ and R³⁶ each independently represent an alkylene group having 1 to 3 carbon atoms]

Examples of the alkylene groups having 1 to 3 carbon atoms represented by R³⁵ and R³⁶ include a methylene group, an ethylene group, and a methylmethylene group, among which a methylene group and an ethylene group are preferred.

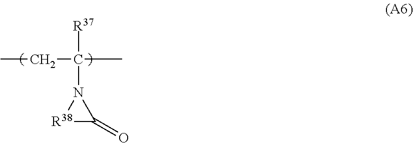

[wherein, R³⁷ represents a hydrogen atom or a methyl group; and R³⁸ represents an alkylene group having 1 to 5 carbon atoms]

The alkylene group having 1 to 5 carbon atoms represented by R³⁸ maybe linear or branched; however, it is preferably linear. The number of carbon atoms of the alkylene group is preferably 3 to 5. Examples of the alkylene group include a methylene group, an ethylene group, a trimethylene group, a propylene group, a butylene group, and a pentylene group.

As a monomer from which the repeating unit (A) is derived, any known compound can be used, and examples thereof include (meth)acrylate monomers, (meth)acrylamide monomer, and other vinyl monomers, among which (meth)acrylate monomers, (meth)acrylamide monomers and the like are preferred. More specific examples thereof include (meth)acrylate monomers, such as hydroxyethyl (meth)acrylate, hydroxypropyl (meth)acrylate, glycerol mono(meth)acrylate, polyethylene glycol (meth)acrylate, polypropylene glycol (meth)acrylate, polyethylene glycol polypropylene glycol (meth)acrylate, polyethylene glycol polytetramethylene glycol (meth)acrylate, polypropylene glycol polytetramethylene glycol (meth)acrylate, methoxypolyethylene glycol (meth)acrylate, ethoxypolyethylene glycol (meth)acrylate, butoxypolyethylene glycol (meth)acrylate, 2-ethylhexylpolyethylene glycol (meth)acrylate, lauroxypolyethylene glycol (meth)acrylate, 2-(meth)acryloyloxyethyl-2′-(trimethylammonio)ethyl phosphate, and N-(meth)acryloyloxyethyl-N,N-dimethylammonium-α-N-methylcarboxybetaine; (meth)acrylamide monomers, such as (meth)acrylamide, N,N-dimethyl (meth)acrylamide, N,N-diethyl (meth)acrylamide, N-ethyl (meth)acrylamide, N-isopropyl (meth)acrylamide, N-methylol (meth)acrylamide, N-(1-hydroxyethyl) (meth)acrylamide, N-methylolpropane (meth)acrylamide, N-methoxymethyl (meth)acrylamide, N-(2-hydroxyethyl) (meth)acrylamide, and N-(meth)acryloyl morpholine; and vinyl monomers, such as N-vinyl-2-pyrrolidone. These monomers maybe used individually or two or more thereof.

Among the above-described monomers, for example, acrylamide monomers, such as N,N-dimethyl (meth)acrylamide, N,N-diethyl (meth)acrylamide, N-ethyl (meth)acrylamide, N-isopropyl (meth)acrylamide, N-methylol (meth)acrylamide, N-(1-hydroxyethyl) (meth)acrylamide, N-methylolpropane (meth)acrylamide, N-methoxymethyl (meth)acrylamide, N-(2-hydroxyethyl) (meth)acrylamide and N-(meth)acryloyl morpholine, and vinyl monomers such as N-vinyl-2-pyrrolidone are preferred, since these monomers allow the present composition and the present coating agent to have excellent storage stability.

The content of the repeating unit (A) in the present polymer is preferably at least not less than 65% by mass, more preferably 75 to 99% by mass, particularly preferably 85 to 98% by mass, with respect to 100% by mass of the polymer. When the content of the repeating unit (A) is in this numerical range, the present composition and the present coating agent that have a superior effect of inhibiting adhesion of the bactericidal compound and lipids are obtained, and a contact lens having excellent effect of inhibiting adhesion of the bactericidal compound and lipids is obtained.

It is noted here that the content of the repeating unit (A) in the present polymer can be measured by ¹H-NMR or the like.

### [Repeating Unit (B)]

The present polymer comprises a repeating unit (B) having an HLB value of 1 to less than 14. The repeating unit (B) is not particularly restricted as long as its HLB value is in the above-described range; however, the repeating unit (B) is preferably a hydrophobic repeating unit. The present polymer may have one, or two or more repeating units corresponding to the repeating unit (B).

From the standpoints of, for example, obtaining the present polymer having excellent effect of removing lipid stains and the like, particularly the present polymer that exhibits, for example, excellent actions (e.g., adsorptivity) on contact lenses and excellent effect of removing lipid stains from contact lenses, the HLB value of the repeating unit (B) is preferably 13 or less, more preferably 10 or less, particularly preferably 8 or less. When the HLB value is 14 or higher, the safety of the present composition may be poor and, particularly, the actions (e.g., adsorptivity) of the present polymer on contact lenses may be insufficient, so that adsorption of the bactericidal compound to a contact lens may not be inhibited.

It is preferred that the repeating unit (B) contain a structure represented by the following Formula (2) or (3), since using the polymer having such repeating unit (B) yields a composition that has excellent effect of inhibiting adsorption of the bactericidal compound and excellent effect of removing lipid stains, as well as a composition and a coating agent that exhibit excellent actions (e.g., adsorptivity) on contact lenses, particularly silicone hydrogel contact lenses, and have excellent effect of inhibiting adsorption of the bactericidal compound to contact lenses and excellent effect of removing lipid stains.

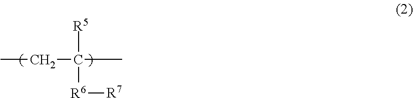

[wherein, R⁵ represents a hydrogen atom or a methyl group; R⁶ represents —O—, *-(C═O)—O—, *-(C═O)—NR⁸—, or *-NR⁸—(C═O)—(R⁸ represents a hydrogen atom or an organic group having 1 to 10 carbon atoms, and * represents a position at which the group is bound to the carbon atom bound with R⁵ in the Formula (2)); and R⁷ represents an organic group having 3 to 100 carbon atoms,

with a proviso that, when R⁶ is *-(C═O)—NR⁸— or *-NR⁸—(C═O)—, R⁷ and R⁸ are optionally bound together to form a ring]

In Formula (2), R⁶ is preferably *-(C═O)—O— or *-(C═O)—NR⁸—, more preferably *-(C═O)—NR⁸—.

R⁸ is preferably a hydrogen atom or an alkyl group having 1 to 10 carbon atoms. The number of carbon atoms of the alkyl group is preferably 1 to 5, more preferably 1 to 3. The alkyl group may be linear or branched, and examples thereof include a methyl group, an ethyl group, an n-propyl group, and an isopropyl group.

In Formula (2), examples of the organic group having 3 to 100 carbon atoms represented by R⁷ include hydrocarbon groups, and groups that have at least one selected from an ether bond, an imino group, an amide bond and an ester bond between carbon-carbon atoms in a hydrocarbon group. The number of carbon atoms of this organic group is preferably 3 to 30, more preferably 4 to 18.

The term “hydrocarbon group” used for R⁷ is a concept that encompasses aliphatic hydrocarbon groups, alicyclic hydrocarbon groups and aromatic hydrocarbon groups, and the hydrocarbon group is preferably an aliphatic hydrocarbon group. The aliphatic hydrocarbon group may be linear or branched. The aliphatic hydrocarbon group is preferably an alkyl group. The number of carbon atoms of the alkyl group is preferably 3 to 30, more preferably 4 to 18. Examples of the hydrocarbon group include an n-butyl group, an isobutyl group, a sec-butyl group, a tert-butyl group, a pentyl group, a hexyl group, a heptyl group, an octyl group, a 2-ethylhexyl group, a nonyl group, a decyl group, an undecyl group, and a dodecyl group.

Further, the groups that have at least one selected from an ether bond, an imino group, an amide bond and an ester bond between carbon-carbon atoms in a hydrocarbon group are preferably groups having an ether bond between carbon-carbon atoms in a hydrocarbon group.

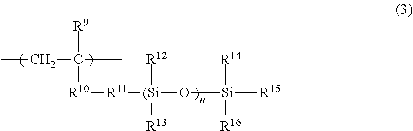

[wherein, R⁹ represents a hydrogen atom or a methyl group; R¹⁰ represents —O—, *-(C═O)—O—, *-(C═O)—NR¹⁷—, *-NR¹⁷—(C═O)—(R¹⁷ represents a hydrogen atom or an organic group having 1 to 10 carbon atoms, and * represents a position at which the group is bound to the carbon atom bound with R⁹ in the Formula (3)), or a phenylene group; R¹¹ represents a divalent organic group having 1 to 10 carbon atoms; R¹² and R¹³ each independently represent an organic group having 1 to 10 carbon atoms; R¹⁴, R¹⁵ and R¹⁶ each independently represent —OSi (R¹⁸)₃ (each R¹⁸ independently represents a hydrogen atom or an organic group having 1 to 8 carbon atoms), or an organic group having 1 to 10 carbon atoms; and n represents 0 to 200 as an average value]

In Formula (3), R¹⁰ is preferably *-(C═O)—O— or *-(C═O)—NR¹⁷—.

R¹⁷ is preferably a hydrogen atom or an alkyl group having 1 to 10 carbon atoms. The number of carbon atoms of the alkyl group is preferably 1 to 5, more preferably 1 to 3. The alkyl group may be linear or branched, and examples thereof include a methyl group, an ethyl group, an n-propyl group, and an isopropyl group.

In Formula (3), the divalent organic group having 1 to 10 carbon atoms represented by R¹¹ is preferably a divalent aliphatic hydrocarbon group, more preferably an alkylene group. The number of carbon atoms of the alkylene group is preferably 1 to 8, more preferably 1 to 6. The alkylene group may be linear or branched, and examples thereof include a methylene group, an ethylene group, a trimethylene group, a propylene group, a tetramethylene group, a pentamethylene group, and a hexamethylene group.

In Formula (3), the organic groups represented by R¹² to R¹⁶ are preferably hydrocarbon groups, more preferably aliphatic hydrocarbon groups. The aliphatic hydrocarbon groups may be linear or branched and are preferably alkyl groups. The number of carbon atoms of the alkyl groups is preferably 1 to 6, more preferably 1 to 4. Examples of the hydrocarbon groups include a methyl group, an ethyl group, an n-propyl group, an isopropyl group, an n-butyl group, an isobutyl group, a sec-butyl group, a tert-butyl group, and a pentyl group.

When there are plural R¹²s and plural R¹³s, the plural R¹²s may be the same or different, and the plural R¹³s may also be the same or different.

The organic group having 1 to 8 carbon atoms represented by R¹⁸ is preferably a hydrocarbon group, more preferably an aliphatic hydrocarbon group. The aliphatic hydrocarbon group may be linear or branched and is preferably an alkyl group. The number of carbon atoms of the alkyl group is preferably 1 to 6, more preferably 1 to 4, particularly preferably 1 to 3. Examples of the hydrocarbon group include a methyl group, an ethyl group, an n-propyl group, and an isopropyl group.

In Formula (3), n is preferably 0 to 100, more preferably 0 to 50, still more preferably 0 to 25, as an average value.

As a monomer from which the repeating unit (B) is derived, any known compound can be used, and it is not particularly restricted; however, among such monomers, for example, (meth)acrylate monomers, (meth)acrylamide monomers, vinyl monomers, olefin monomers, styrene monomers, and vinyl ether monomers are preferred.

From the standpoints of, for example, obtaining a composition and a coating agent that have excellent storage stability, the repeating unit (B) is preferably a repeating unit derived from a (meth)acrylamide monomer.

More specific examples of the monomer from which the repeating unit (B) is derived include (meth)acrylate monomers, such as n-butyl (meth)acrylate, tert-butyl (meth)acrylate, cyclohexyl (meth)acrylate, 2-ethylhexyl (meth)acrylate, octyl (meth)acrylate, lauryl (meth)acrylate, isodecyl (meth)acrylate, stearyl (meth)acrylate, cyclohexyl methacrylate, benzyl (meth)acrylate, phenoxyethyl (meth)acrylate, isobornyl (meth)acrylate, dicyclopentanyl (meth)acrylate, 3-[tris(trimethylsiloxy)silyl]propyl (meth)acrylate, 3-[bis(trimethylsiloxy)(methyl)silyl]propyl (meth)acrylate, and silicone (meth)acrylate (e.g., X-22-2475 (manufactured by Shin-Etsu Chemical, Co. Ltd.) and FM-0711 (manufactured by JNC Corporation)); acrylamide monomers, such as N,N-di-n-propyl (meth)acrylamide, N,N-diisopropyl (meth)acrylamide, N,N-di(n-butyl) (meth)acrylamide, N,N-di(tert-butyl) (meth)acrylamide, N-n-butyl (meth)acrylamide, N-tert-butyl (meth)acrylamide, N-n-hexyl (meth)acrylamide, N-n-octyl (meth)acrylamide, N-tert-octyl (meth)acrylamide, N-dodecyl (meth)acrylamide, N,N-diglycidyl (meth)acrylamide, N-(4-glycidoxybutyl) (meth)acrylamide, N-(5-glycidoxypentyl) (meth)acrylamide, N-n-butoxymethyl (meth)acrylamide, N-tert-butoxymethyl (meth)acrylamide, N-isobutoxymethyl (meth)acrylamide, and N-phenyl (meth)acrylamide; vinyl monomer, such as (meth)acrylonitrile, vinyl acetate, vinyl chloride, and vinylidene chloride; olefin monomers, such as ethylene, propylene, and butene; styrene monomers, such as styrene and α-methylstyrene; butadiene; and isoprene. These monomers maybe used individually or two or more thereof.

The monomer from which the repeating unit (B) is derived is more preferably a (meth)acrylamide monomer, and specific examples thereof include N,N-di-n-propyl (meth)acrylamide, N,N-diisopropyl (meth)acrylamide, N,N-di(n-butyl) (meth)acrylamide, N,N-di(tert-butyl) (meth)acrylamide, N-n-butyl (meth)acrylamide, N-tert-butyl (meth)acrylamide, N-n-hexyl (meth)acrylamide, N-n-octyl (meth)acrylamide, N-tert-octyl (meth)acrylamide, N-dodecyl (meth)acrylamide, (meth)acrylamide, N-(4-glycidoxybutyl) (meth)acrylamide, N-(5-glycidoxypentyl) (meth)acrylamide, N-n-butoxymethyl (meth)acrylamide, N-tert-butoxymethyl (meth)acrylamide, N-isobutoxymethyl (meth)acrylamide, and N-phenyl (meth)acrylamide.

The content of the repeating unit (B) in the present polymer is preferably at least not less than 0.1% by mass, more preferably 0.1 to 25% by mass, particularly preferably 2 to 15% by mass, with respect to 100% by mass of the polymer. When the content of the repeating unit (B) is in this numerical range, a polymer having excellent solubility in water can be obtained, and a polymer having an excellent balance between the solubility in water and the adsorptivity to the surface of a contact lens, particularly a silicone hydrogel contact lens, can be obtained. It is noted here that the content of the repeating unit (B) in the present polymer can be measured by ¹H-NMR or the like.

The present polymer may contain other repeating unit (s) in addition to the above-described repeating units (A) and (B) within a range that does not impair the effects of the present invention; however, from the standpoints of, for example, obtaining a composition and a coating agent that are not less likely to deteriorate the bactericidal action of a bactericidal compound, it is preferred that the present polymer contain substantially no acidic group-containing repeating unit as other repeating unit.

In the present polymer, the total amount of the repeating units (A) and (B) is preferably not less than 80% by mass, more preferably not less than 90% by mass, still more preferably not less than 95% by mass.

### [Method of Synthesizing Present Polymer]

The present polymer can be synthesized, for example, in the following manner. That is, at least one compound each is selected from monomers deriving the repeating unit (A) and monomers deriving the repeating unit (B), and the thus selected compounds are mixed. As required, the resulting mixture is dissolved in a solvent, such as water, acetonitrile, ethanol, 2-propanol, or 1,4-dioxane. Then, a polymerization initiator is added to the thus obtained solution to perform radical polymerization, whereby the desired polymer can be obtained.

The polymerization initiator used for performing the radical polymerization is not particularly restricted as long as it is a known radical polymerization initiator, and examples thereof include benzoyl peroxide, lauroyl peroxide, diisopropyl peroxydicarbonate, tert-butyl peroxy-2-ethylhexanoate, tert-butyl peroxypivalate, t-butyl peroxydiisobutyrate, azobis-isobutyronitrile, azobis-isodimethylvaleronitrile, 2,2′-azobis[2-(2-imidazolin-2-yl)propane]dihydrochloride, persulfates, and persulfate-bisulfite polymerization initiators.

The polymerization initiator is used in an amount of preferably 0.001 to 10 parts by mass, more preferably 0.001 to 5 parts by mass, with respect to 100 parts by mass of the monomer components.

The polymerization temperature is preferably 20 to 100° C., and the polymerization time is preferably 0.5 to 48 hours.

### [Properties, etc. of Present Polymer]

The present polymer is not particularly restricted as long as it has the repeating units (A) and (B), and the present polymer may be any of a block copolymer, a graft copolymer, a random copolymer and an alternating copolymer.

From the standpoints of, for example, reducing the cytotoxicity through hydrophobic interaction with the bactericidal compound and, particularly, obtaining a polymer showing excellent adsorption to the surface of a contact lenses, especially a silicone hydrogel contact lens, the weight-average molecular weight (Mw) of the present polymer is preferably 5,000 to 10,000,000, more preferably 10,000 to 5,000,000, still more preferably 10,000 to 3,000,000, particularly preferably 10,000 to 2,000,000. Further, the molecular weight distribution (Mw/Mn) is preferably 1 to 10, more preferably 1 to 7, particularly preferably 1 to 5. It is noted here that the weight-average molecular weight and the molecular weight distribution may be measured in accordance with the methods described below in the section of Examples.

The present polymer is preferably a polymer that dissolves in water (water-soluble polymer).

From the standpoints of, for example, obtaining a composition that exhibits excellent ability of cleaning lipid stains and has excellent properties of inhibiting adsorption of the bactericidal compound, particularly a composition that exhibits excellent ability of adsorbing to contact lenses and excellent ability of cleaning lipid stains adhered to contact lenses and has excellent properties of inhibiting adsorption of the bactericidal compound to a contact lens, the above-described water-soluble polymer is, for example, a polymer having an HLB value of preferably 15 or higher, more preferably 17 or higher.

The HLB value of a polymer can be determined from the introduction ratios and the structures of the respective repeating units that were derived from a ¹H-NMR spectrum and, specifically, the HLB value of a polymer can be measured and calculated by the method described below in the section of Examples.

The present polymer used in the present coating agent is preferably a polymer that dissolves in a lower alcohol having about 1 to 4 carbon atoms or water.

The term “dissolve” used herein means that, when the present polymer is added to and mixed with a lower alcohol or water (25° C.) such that a polymer solid content of 0.5% by mass is attained, the resultant is visually transparent.

### «Composition»

The present composition comprises a bactericidal compound along with the present polymer.

The bactericidal compound is not particularly restricted as long as it has a cationic group, and any known compound can be used. Examples thereof include polyhexamethylene biguanide derivatives, such as polyhexanide hydrochloride (polyhexamethylene biguanide (PHMB)); polidronium chloride derivatives, such as polidronium chloride; polyquaternium derivatives, such as polyquaternium; chlorhexidine derivatives, such as chlorhexidine; benzalkonium chloride derivatives, such as benzalkonium chloride; and benzethonium chloride derivatives, such as benzethonium chloride; however, from the standpoints of, for example, obtaining a compound that is highly safe (e.g., low cytotoxicity) while having a bactericidal effect, particularly a composition that is unlikely to cause infiltration or accumulation thereof inside a contact lens and has sufficient bactericidal effect, the bactericidal compound is preferably polyhexanide hydrochloride or polidronium chloride.

These bactericidal compounds may be used individually or two or more thereof.

The concentration of the bactericidal compound in the present composition is preferably 0.1 to 100 ppm, more preferably 0.1 to 50 ppm, still more preferably 0.5 to 10 ppm. When the concentration of the bactericidal compound is in this range, a composition that exhibits excellent bactericidal and bacteriostatic actions and has superior safety can be obtained.

The lower limit of the concentration of the preset polymer is preferably 0.001% by mass, more preferably 0.01% by mass, particularly preferably 0.05% by mass, with respect to 100% by mass of the present composition, and the upper limit of the concentration of the present polymer is preferably 10% by mass, more preferably 5% by mass, still more preferably 3% by mass, particularly preferably 1% by mass, with respect to 100% by mass of the present composition. When the content of the present polymer is in this range, a composition in which a reduction in the bactericidal action of the bactericidal compound is further inhibited and which has superior ability of inhibiting adsorption of the bactericidal compound and lipids as well as superior safety can be obtained. Particularly, when the present composition is used as a contact lens cleaning agent or a contact lens solution, the content of the present polymer in the cleaning agent or the solution is preferably 0.001 to 5% by mass, more preferably 0.05 to 3% by mass.

In addition to the present polymer and the bactericidal compound, the present composition may also contain, for example, a solvent, a surfactant, an isotonizing agent, a chelating agent, a pH modifier, a buffer, a thickening agent, a stabilizer, a protease, a pharmacologically active component, a physiologically active component, and the various additives described in Japanese Pharmaceutical Excipients Directory 2007 (edited by the International Pharmaceutical Excipients Council Japan). In the present composition, these components may be used individually or two or more thereof.

The present composition is preferably an ophthalmic, cleaning, cosmetic, medical, or quasi drug composition.

### <Ophthalmic Composition>

The form of the ophthalmic composition is not restricted as long as it is a composition that is applied to the eye or an instrument fitted to the eye.

Examples of the composition applied to the eye include eye drops and eye washes.

Examples of the composition applied to an instrument fitted to the eye (e.g., contact lens) include contact lens cleaning solutions, contact lens solutions, and contact lens fitting liquids.

Thereamong, contact lens cleaning solutions, contact lens solutions, and eye drops are particularly preferred.

The present composition has excellent properties of removing lipid stains and inhibiting lipid adhesion and is extremely safe while maintaining a bactericidal action provided by the bactericidal compound and, specifically, the present composition has low cytotoxicity and exhibits low adsorption of the bactericidal compound. Further, the present composition exhibits high hydrolysis resistance and has excellent storage stability.

Therefore, the present composition is useful as a contact lens cleaning solution and a contact lens solution, and the use of the present composition as an eye drop does not cause any problem even when the composition is applied to the eye while wearing a contact lens.

The present composition can be used for any of various soft contact lenses and hard contact lenses including non-hydrous, low-hydrous and highly hydrous contact lenses; however, among such contact lenses, the present composition can be advantageously used for soft contact lenses, particularly silicone hydrogel contact lenses whose surfaces are difficult to modify.

### <Cleaning Composition and Cosmetic Composition>

As described above, the present composition exhibits excellent removal of lipid stains and is extremely safe while maintaining a bactericidal action provided by the bactericidal compound and, specifically, the present composition has low cytotoxicity and exhibits excellent suppression of irritation caused by the bactericidal compound; therefore, the present composition can be used as, for example, a cleaning composition or cosmetic composition for washing and treating human skin, scalp, hair and the like.

Examples of such compositions include shampoos, rinses, body soaps, shower gels, hand washing agents, facial cleansers, make-up removers, bath preparations, baby care products, and detergents.

### <Medical Composition and Quasi Drug Composition>

The present composition can be used as a medical composition or quasi drug composition for sterilization or disinfection of ocular mucosa or epidermis, which composition contains the above-described bactericidal compound as an active ingredient.

Examples of such compositions include eye drops, eye washes, and finger/hand or skin disinfectants.

### «Coating Agent»

The present coating agent is characterized by comprising the present polymer. By coating the contact lens surface with the present coating agent, adsorption of the cationic group-containing bactericidal compound to the contact lens can be inhibited while inhibiting a reduction in the bactericidal action of the bactericidal compound. Therefore, by coating the contact lens surface with the present coating agent, a contact lens which is unlikely to cause ophthalmopathy such as corneal staining even when the eye comes into contact with the composition comprising the cationic group-containing bactericidal compound can be obtained. Further, the present coating agent has not only excellent effect of hydrophilizing the surface of contact lenses, particularly contact lenses having a hydrophobic surface, but also excellent effect of inhibiting adsorption of lipids to contact lenses. Moreover, since the present coating agent is highly adsorptive to contact lenses and thus unlikely to be peeled off therefrom, the present coating agent has excellent sustainability of the above-described hydrophilization effect.

From the standpoints of, for example, obtaining a coating agent that is excellent in the above-described effects, the content of the present polymer in the present coating agent is preferably 0.001 to 20% by mass, more preferably 0.01 to 15% by mass, still more preferably 0.1 to 10% by mass.

The present coating agent may also contain a solvent in addition to the present polymer, and examples of the solvent include water; various buffer solutions, such as phosphate buffer, glycine buffer, Good's buffer, Tris buffer, and ammonia buffer; and alcohol solvents, such as methanol, ethanol, and isopropyl alcohol. These solvents may be used individually or two or more thereof.

In the present coating agent, the content of the solvent(s) is preferably 50 to 99.9% by mass, more preferably 80 to 99.9% by mass.

In addition to the present polymer and the solvent(s), the present coating agent may further contain an additive(s), such as a disinfectant and a preservative.

### «Contact Lens and Production Method Thereof»

The present contact lens is characterized by comprising the present polymer on at least a part of the surface thereof. The method of producing the present contact lens comprises the step of coating the present polymer on at least a part of the surface of a contact lens.

Since the present contact lens and a contact lens obtained by the above-described production method have the present polymer on at least a part of the surface thereof, adsorption of the bactericidal compound and lipids to these contact lenses are unlikely to occur.

Examples of a method of coating at least apart of a contact lens with the present coating agent include (1) a method of bringing the coating agent into contact with the contact lens and thereby allowing the present polymer contained in the coating agent to physically adsorb to the contact lens surface; and (2) a method of bringing the coating agent containing a solvent into contact with the contact lens, evaporating the solvent by drying, and then forming a film comprising the present polymer on the contact lens surface. In the method (1), when an agent containing a solvent is used as the coating agent, the present polymer is allowed to physically adsorb and, usually, the step of removing the solvent is subsequently performed, whereby a contact lens to which the present polymer has adsorbed is obtained.

The contact lens is preferably a soft contact lens, more preferably a silicone hydrogel contact lens. Further, the contact lens may be subjected to, for example, a plasma treatment, a UV-ozone treatment, or a treatment with an internal wetting agent.

### EXAMPLES

The present invention will now be described in detail by way of examples thereof; however, the present invention is not restricted to the following examples.

### <Measurement of Molecular Weight>

The weight-average molecular weight (Mw) and the number-average molecular weight (Mn) were measured by gel permeation chromatography (GPC) based on a polystyrene standard, using a TSKgel α-M column manufactured by Tosoh Corporation under the following analysis conditions: flow rate=0.5 mL/min, elution solvent=NMP solvent (H₃PO₄: 0.016 M, LiBr: 0.030 M), and column temperature=40° C. Further, from the thus measured Mw and Mn, the molecular weight distribution (Mw/Mn) was calculated.

### <NMR Spectrum>

The ¹H-NMR spectrum was measured by Model AVANCE 500 (500 MHz) manufactured by Bruker Corp. using d₆-DMSO as a solvent and DSS-d6 manufactured by Wako Pure Chemical Industries, Ltd. as an internal standard substance.

### <Measurement of HLB>

The HLB values of the repeating units (A) and (B) contained in the polymers obtained below were calculated from the ratio of the organic factor and the inorganic factor as described above (Oda method), and the HLB values of the polymers obtained below were determined from the introduction ratios and the structures of the respective repeating units that were derived from ¹H-NMR spectrum measured in the same manner as described above.

### <Materials Used>

The materials used for the synthesis of the polymers described below were as follows.

### <Hydrophilic Monomers>

“ACMO”: acryloyl morpholine (manufactured by KJ Chemicals Corporation)

“DMAA”: N,N-dimethylacrylamide (manufactured by KJ Chemicals Corporation)

“HEAA”: N-(2-hydroxyethyl)acrylamide (manufactured by KJ Chemicals Corporation)

“GLBT”: N-methacryloyloxyethyl-N,N-dimethylammonium-α-N-methylcarboxy betaine (manufactured by Osaka Organic Chemical Industry Ltd.)

“NVP”: N-vinyl-2-pyrrolidone (manufactured by Wako Pure Chemical Industries, Ltd.)

“MPC”: 2-methacryloyloxyethyl-2′-(trimethylammonio)ethyl phosphate (manufactured by NOF Corporation)

### <Hydrophobic Monomers>

“DDAA”: dodecylacrylamide (manufactured by Tokyo Chemical Industry Co., Ltd.)

“NBMA”: N-butoxymethylacrylamide (manufactured by MRC Unitec Co., Ltd.)

“TRIS”: 3-[tris(trimethylsiloxy)silyl]propyl methacrylate (manufactured by JNC Corporation)

“EHA”: 2-ethylhexyl acrylate (manufactured by Wako Pure Chemical Industries, Ltd.)

### <Polymerization Initiators>

“AIBN”: 2,2′-azobis(isobutyronitrile) (manufactured by Wako Pure Chemical Industries, Ltd.)

“VA-044”: 2,2′-azobis[2-(2-imidazolin-2-yl)propane]dihydrochloride (manufactured by Wako Pure Chemical Industries, Ltd.)

### <Molecular Weight Modifier>

“TG”: 1-thioglycerol (manufactured by Asahi Kagaku Kogyo Co., Ltd.)

### <Solvents>

“ACN”: acetonitrile (manufactured by Wako Pure Chemical Industries, Ltd.)

“EtOH”: ethanol (manufactured by Wako Pure Chemical Industries, Ltd.)

water

### Synthesis Example 1

### Synthesis of Copolymer (N-1)

In a flask, 14.25 g of DMAA, 0.75 g of DDAA, 0.3 g of AIBN as a polymerization initiator, and 61.2 g of ACN were added and mixed together. Then, nitrogen was blown into this flask, and the resulting mixture was heated to 70° C. and allowed to polymerize at this temperature for 8 hours, after which the resultant was cooled to room temperature. The thus obtained solution was dialyzed with pure water, whereby a copolymer (N-1) was obtained. In the thus obtained copolymer (N-1), the DMAA content was 95% by mass, and the DDAA content was 5% by mass. It is noted here that these content values were measured by ¹H-NMR. The thus obtained copolymer (N-1) had a weight-average molecular weight of 156,000, a number-average molecular weight of 37,000, and a molecular weight distribution of 4.22.

Further, using the thus obtained copolymer (N-1), a 0.5%-by-mass aqueous solution of the copolymer (N-1) was obtained. This aqueous solution was visually observed, and the copolymer (N-1) was evaluated to be soluble in water when the aqueous solution was transparent.

### Synthesis Examples 2 to 6 and 8 to 11

### Synthesis of Copolymers (N-2 to N-6 and N-8 to N-11)

Copolymers (N-2 to N-6 and N-8 to N-11) were obtained in the same manner as in Synthesis Example 1, except that the respective monomer species shown in Table 1 were used in such amounts that yielded amounts (% by mass) of the repeating units (A) and (B) in each copolymer as shown in Table 1; the respective polymerization initiator shown in Table 1 was used in the amount shown in Table 1; and the respective solvent shown in Table 1 was used. Further, using the thus obtained copolymers, 0.5%-by-mass aqueous solutions of the copolymer (N-2) to (N-6) and (N-8) to (N-10) were each obtained. It is noted here that, when the copolymer (N-11) was used, an aqueous solution could not be prepared due to cloudiness.

### Synthesis Example 7

### Synthesis of Copolymer (N-7)

A block copolymer (N-7) was synthesized by a widely used RAFT polymerization method using “DTMPA” (2-(dodecylthiocarbonothioylthio)-2-methylpropionic acid, manufactured by Sigma-Aldrich) as a RAFT (Reversible Addition-Fragmentation Chain Transfer) agent, and “DOX” (1,4-dioxane, manufactured by Wako Pure Chemical Industries, Ltd.) as a solvent.

Specifically, 0.4 g of EHA, 0.0326 g of DTMPA, 0.0007 g of AIBN, and 10 mL of DOX were added to a flask and, after subjecting the resulting solution to nitrogen bubbling, the solution was stirred at 70° C. for 13 hours. Then, 7.60 g of DMAA and 10 mL of DOX were added thereto, and the resultant was further stirred at 70° C. for 24 hours. After the completion of the reaction, the reaction solution was added to diethyl ether and further washed with diethyl ether three times, after which the resultant was vacuum-dried, whereby an A-B type block copolymer (N-7) was synthesized.

Thereafter, the thus obtained copolymer was dissolved in water to obtain a 0.5%-by-mass aqueous solution.

### Reference Examples 1 and 2

### Synthesis of (Co)polymers (N-12 and N-13)

(Co)polymers (N-12 and N-13) were obtained in the same manner as in Synthesis Example 1, except that the respective monomer species shown in Table 1 were used in such amounts that yielded amounts (% by mass) of the repeating units (A) and (B) in each (co)polymer as shown in Table 1; the respective polymerization initiator and molecular weight modifier shown in Table 1 were used in the amounts shown in Table 1; and the respective solvent shown in Table 1 was used.

Thereafter, the thus obtained (co)polymers were each dissolved in water at a concentration of 0.5% by mass to obtain aqueous solutions.

It is noted here that the amounts (parts) of the polymerization initiators and molecular weight modifiers shown in Table 1 mean “parts by mass” of the respective polymerization initiators and molecular weight modifiers with respect to a total of 100 parts by mass of the monomers.

TABLE 1

| | | Synthesis Examples and Reference Examples | | | | | | |
|---|---|---|---|---|---|---|---|---|
| | | Synthesis | Synthesis | Synthesis | Synthesis | Synthesis | Synthesis | Synthesis |
| | | Example 1 | Example 2 | Example 3 | Example 4 | Example 5 | Example 6 | Example 7 |
| Polymer | Repeating unit (A-1)-forming | DMAA | HEAA | DMAA | HEAA | NVP | MPC | DMAA |
| synthesis | monomer species | | | | | | | |
| materials | Repeating unit (A-2)-forming | | | | | | | |
| | monomer species | | | | | | | |
| | Repeating unit (B)-forming | DDAA | DDAA | NBMA | TRIS | TRIS | TRIS | EHA |
| | monomer species | | | | | | | |
| | Polymerization initiator | AIBN | AIBN | AIBN | AIBN | AIBN | AIBN | AIBN |
| | | 2 parts | 2 parts | 2 parts | 2 parts | 2 parts | 2 parts | 0.009 parts |
| | Solvent | ACN | EtOH | ACN | EtOH | ACN | EtOH | DOX |
| | Molecular weight modifier | — | — | — | — | — | — | DTMPA |
| | | | | | | | | 0.42 parts |
| Polymer | Temperature [° C.] | 70 | 70 | 70 | 70 | 70 | 70 | 70 |
| synthesis | Time [hr] | 8 | 8 | 8 | 8 | 8 | 8 | 24 |
| conditions | | | | | | | | |
| Polymer name | | N-1 | N-2 | N-3 | N-4 | N-5 | N-6 | N-7 |
| Polymer | Amount of repeating unit | 95.0 | 95.0 | 85.0 | 95.0 | 98.0 | 95.0 | 95.0 |
| formulation | (A-1) [% by mass] | | | | | | | |
| | HLB of repeating unit (A-1) | 22.2 | 30.0 | 22.2 | 30.0 | 17.6 | 33.3 | 22.2 |
| | Amount of repeating unit | | | | | | | |
| | (A-2) [% by mass] | | | | | | | |
| | HLB of repeating unit (A-2) | | | | | | | |
| | Amount of repeating unit | 5.0 | 5.0 | 15.0 | 5.0 | 2.0 | 5.0 | 5.0 |
| | (B) [% by mass] | | | | | | | |
| | HLB of repeating unit (B) | 6.7 | 6.7 | 13.8 | 3.6 | 3.6 | 3.6 | 2.9 |
| Polymer | Polymer HLB | 21.2 | 28.4 | 20.8 | 28.8 | 17.3 | 32.8 | 21.0 |
| properties | Weight-average molecular | 15.6 | 4.5 | 14.8 | 4.3 | 8.5 | 2.5 | 8.0 |
| | weight (×10,000) | | | | | | | |
| | Number-average molecular | 3.7 | 1.8 | 3.6 | 1.9 | 1.9 | 1.2 | 6.5 |
| | weight (×10,000) | | | | | | | |
| | Molecular weight distribution | 4.22 | 2.50 | 4.10 | 2.26 | 4.47 | 2.08 | 1.23 |
| | Solubility in water | transparent | transparent | transparent | transparent | transparent | transparent | transparent |
| | (0.5% by weight) | | | | | | | |

| | | Synthesis Examples and Reference Examples | | | | | |
|---|---|---|---|---|---|---|---|
| | | Synthesis | Synthesis | Synthesis | Synthesis | Reference | |
| | | Example 8 | Example 9 | Example 10 | Example 11 | Example 1 | Reference Example 2 |
| Polymer | Repeating unit (A-1)-forming | GLBT | ACMO | DMAA | DMAA | DMAA | HEAA |
| synthesis | monomer species | | | | | | |
| materials | Repeating unit (A-2)-forming | | | GLBT | | | |
| | monomer species | | | | | | |
| | Repeating unit (B)-forming | DDAA | DDAA | DDAA | DDAA | — | — |
| | monomer species | | | | | | |
| | Polymerization initiator | AIBN | AIBN | AIBN | AIBN | VA-044 | VA-044 |
| | | 2 parts | 2 parts | 2 parts | 2 parts | 4 parts | 4 parts |
| | Solvent | EtOH | ACN | EtOH | EtOH | water | water |
| | Molecular weight modifier | — | — | — | — | TG | TG |
| | | | | | | 0.1 parts | 0.2 parts |
| Polymer | Temperature [° C.] | 70 | 70 | 70 | 70 | 60 | 80 |
| synthesis | Time [hr] | 8 | 8 | 8 | 8 | 8 | 8 |
| conditions | | | | | | | |
| Polymer name | | N-8 | N-9 | N-10 | N-11 | N-12 | N-13 |
| Polymer | Amount of repeating unit | 95.0 | 95.0 | 90.0 | 60.0 | 100.0 | 100.0 |
| formulation | (A-1) [% by mass] | | | | | | |
| | HLB of repeating unit (A-1) | 41.8 | 17.7 | 22.2 | 22.2 | 22.2 | 30.0 |
| | Amount of repeating unit | | | 5.0 | | | |
| | (A-2) [% by mass] | | | | | | |
| | HLB of repeating unit (A-2) | | | 41.8 | | — | — |
| | Amount of repeating unit | 5.0 | 5.0 | 5.0 | 40.0 | | |
| | (B) [% by mass] | | | | | | |
| | HLB of repeating unit (B) | 6.7 | 6.7 | 6.7 | 6.7 | | |
| Polymer | Polymer HLB | 40.3 | 17.6 | 22.8 | 14.8 | 22.2 | 30.0 |
| properties | Weight-average molecular | 3.6 | 13.9 | 4.4 | 16.4 | 18.3 | 17.3 |
| | weight (×10,000) | | | | | | |
| | Number-average molecular | 1.5 | 4.5 | 1.7 | 4.5 | 5.5 | 5.9 |
| | weight (×10,000) | | | | | | |
| | Molecular weight distribution | 2.40 | 3.09 | 2.59 | 3.64 | 3.33 | 2.93 |
| | Solubility in water | transparent | transparent | transparent | cloudy | transparent | transparent |
| | (0.5% by weight) | | | | | | |

### Example 1

A liquid agent was obtained by mixing 0.5 parts by mass of the copolymer (N-1) obtained in Synthesis Example 1, 0.0001 parts by mass of polyhexamethylene biguanide (hereinafter, also referred to as “PHMB”), and 99.5 parts by mass of physiological saline.

### Examples 2 to 10

Liquid agents were each obtained in the same manner as in Example 1 by mixing 0.5 parts by mass of the respective copolymers (N-2) to (N-10) obtained in Synthesis Examples 2 to 10, 0.0001 parts by mass of PHMB, and 99.5 parts by mass of physiological saline.

### Example 11

A liquid agent was obtained by mixing 0.5 parts by mass of the copolymer (N-1) obtained in Synthesis Example 1, 0.003 parts by mass of benzalkonium chloride, and 99.5 parts by mass of physiological saline.

### Example 12

A liquid agent was obtained in the same manner as in Example 11 by mixing 0.5 parts by mass of the copolymer (N-4) obtained in Synthesis Example 4, 0.003 parts by mass of benzalkonium chloride, and 99.5 parts by mass of physiological saline.

### Comparative Examples 1 and 2

Liquid agents were each obtained in the same manner as in Example 1 by mixing 0.5 parts by mass of the respective copolymers (N-12) and (N-13) obtained in Reference Examples 1 and 2, 0.0001 parts by mass of PHMB, and 99.5 parts by mass of physiological saline.

### Comparative Example 3

A liquid agent was obtained in the same manner as in Example 11 by mixing 0.5 parts by mass of the copolymer (N-12) obtained in Reference Example 1, 0.003 parts by mass of benzalkonium chloride, and 99.5 parts by mass of physiological saline.

In the following tests, the below-described Controls 1 and 2 were used as controls.

As Control 1, a liquid agent obtained by mixing 0.0001 parts by mass of PHMB and 100.0 parts by mass of physiological saline was used. Further, as Control 2, a liquid agent obtained by mixing 0.003 parts by mass of benzalkonium chloride and 100.0 parts by mass of physiological saline was used.

### Test Example 1

### Lipid Cleaning Test

First, prior to the test, a lipid solution was prepared by heat-dissolving 1% by mass of Sudan Black B (dye) in 99% by mass of lipid triglyceride, and 200 μL of this lipid solution was added dropwise to a screw cap bottle such that a smooth solution surface was obtained, after which the solution was cooled at room temperature, whereby a screw cap bottle containing colored pseudo-eye discharge pellets was prepared.

Subsequently, 1 mL of each of the liquid agents of Examples 1 to 12, Comparative Examples 1 to 3 and Controls 1 and 2 was added to this pellet-containing screw cap bottle, and the bottle was shaken at room temperature for 14 hours to dissolve the colored pseudo-eye discharge pellets. Then, after the completion of the shaking, the resulting solution was taken out of the screw cap bottle, and the absorbance at a wavelength of 570 nm was measured using Model 680 Microplate Reader (manufactured by Bio-Rad Laboratories, Inc.). The results thereof are shown in Table 2.

It is noted here that a higher absorbance shows a greater colored pseudo-eye discharge pellet-dissolving power, that is, superior lipid-cleaning effect.

In Table 2, the numerical values of Examples 1 to 10 and Comparative Examples 1 and 2 each indicate the absorbance, taking the absorbance of Control 1 as 0.000. Further, in Table 2, the numerical values of Examples 11 and 12 and Comparative Example 3 each indicate the absorbance, taking the absorbance of Control 2 as 0.000. As shown in Table 2, those liquid agents containing the present polymer (Examples 1 to 12) exhibited a lipid-cleaning power.

On the other hand, those liquid agents containing a polymer consisting of only the repeating unit (A) (Comparative Examples 1 to 3) exhibited substantially no lipid-cleaning power.

### Test Example 2

### Disinfecting Effect Test

Trophozoites of pre-cultured Acanthamoeba (Acanthamoeba castellanii ATCC50370) were collected from a flask, and a suspension thereof having a concentration of 5×10⁵ cells/mL was prepared using a ¼ Ringer's solution. Subsequently, 5 mL of each of the liquid agents of Examples 1 to 12, Comparative Examples 1 to 3 and Controls 1 and 2 was placed in a test tube, and 50 μL of the thus obtained Acanthamoeba suspension was added to each test tube, followed by stirring, whereby diluted suspensions containing 5×10³ cells/mL of the amoeba were prepared.

Then, after leaving the diluted suspensions for 4 hours at 22° C., 20 μL of each suspension was collected, and 10-fold serial dilutions thereof were performed by a method of mixing the suspension with 180 μL of a neutralizing solution (¼ Ringer's solution to which lecithin polysorbate was added). To each diluted suspension of the serial dilution steps, 50 μL of Escherichia coli suspension adjusted to 1×10⁸ cfu was added, and the amoeba were cultured in wells for 14 days. After the culturing, the number of remaining amoebae was measured in the wells. From this measured value, the number of remaining amoebae per 1 mL of the diluted suspension after the treatment at 22° C. for 4 hours was calculated. Thereafter, the log reduction value was calculated using the following equation (α), and the bactericidal action was evaluated based on the following evaluation criteria. The results thereof are shown in Table 2.

Log reduction=log(Number of amoebae per 1 mL of diluted suspension immediately after preparation)−log(Number of remaining amoebae per 1 mL of diluted suspension after treatment at 22° C. for 4 hours) (α)

### <Evaluation Criteria>

⊚: The log reduction was 3 or greater.

∘: The log reduction was 1 to less than 3.

×: The log reduction was less than 1.

As shown in Table 2, those liquid agents containing the present polymer (Examples 1 to 12) exhibited a disinfecting effect (bactericidal action) at an equivalent level as the liquid agents containing no polymer (Controls 1 and 2).

### Test Example 3

### Cytotoxicity Test

As a commercially available silicone hydrogel contact lens, ACUVUE OASYS (manufactured by Johnson & Johnson K.K.) belonging to the Group II of FDA classification (non-ionic, low water content) was taken out of the wrapping package and allowed to swell in physiological saline maintained at 25° C. Subsequently, the lens was removed from physiological saline and left to stand for about 4 hours in 4 mL of each of the liquid agents of Examples 1 to 12, Comparative Examples 1 to 3 and Controls 1 and 2. Then, the lens was removed from each liquid agent, and immersed again and left to stand for about 4 hours in 4 mL of each of fresh liquid agents of Examples 1 to 12, Comparative Examples 1 to 3 and Controls 1 and 2 that were separately prepared from the liquid agents used above. This operation of immersing the lens in each liquid agent was repeated for a total of 30 times to prepare a treated lens.

About 100 V79 cells (Chinese hamster lung-derived fibroblasts) were inoculated into a cell culture medium (5%-by-volume fetal bovine serum-added MEM medium) accommodated in wells and left to stand for 4 hours, after which the above-prepared treated lens was placed in each well. Then, the cells were cultured for one week in this state, and the number of colonies was counted. Further, also for control wells in which treated lens was not placed, one-week culturing was performed in the same manner, and the number of colonies was counted. The above-described operations were performed for 4 wells each. Thereafter, the colony formation rate was calculated using the following equation (3) and evaluated based on the following evaluation criteria. The results thereof are shown in Table 2.

Colony formation rate (%)=(Average number of colonies formed in the culture medium in which the treated lens was immersed)/(Average number of colonies formed in the culture medium in which the treated lens was not immersed)×100 (β)

### <Evaluation Criteria>

∘: The colony formation rate was 80% or higher.

Δ: The colony formation rate was 10% to less than 80%.

×: The colony formation rate was less than 10%.

The liquid agents of Examples 1 to 12 were found to have a low cytotoxicity.

### Test Example 4

### Lipid Stain Inhibition Test

First, a homogenized lipid solution was prepared by heat-stirring 1.20% by mass of oleic acid, 1.20% by mass of linoleic acid, 16.23% by mass of tripalmitin, 4.01% by mass of cetyl alcohol, 1.20% by mass of palmitic acid, 16.23% by mass of cetyl palmitate, 1.60% by mass of cholesterol, 1.60% by mass of cholesterol palmitate and 56.73% by mass of lecithin, and 0.5 parts by mass of this lipid solution and 99.5 parts by mass of water were mixed and emulsified to prepare an artificial lipid solution.

Next, as contact lenses, commercially available contact lenses composed of silicone hydrogel (ACUVUE OASYS, manufactured by Johnson & Johnson K. K.) were prepared and washed with PBS buffer three times. The thus washed contact lenses were immersed in 1 mL of each of the liquid agents of Examples 1 to 12, Comparative Examples 1 to 3 and Controls 1 and 2 and left to stand at room temperature for 2 hours, after which the lenses were taken out of each liquid agent and washed with PBS buffer three times.

Subsequently, the thus treated contact lenses were each immersed in 1 mL of the above-described artificial lipid solution and, after shaking for 1 hour, the contact lenses were each taken out, washed with PBS buffer three times and vacuum-dried. Then, the contact lenses were each immersed in 1 mL of an ethanol/diethyl ether (75/25% by volume) solution and left to stand for 30 minutes, whereby lipids adhered to each contact lens were extracted. The resulting extracts were each collected in an amount of 0.5 mL in a test tube, and the solvent was evaporated at 90° C. Thereafter, 0.5 mL of concentrated sulfuric acid was added to each test tube from which the solvent had been evaporated, and the resultant was heated for 30 minutes at 90° C. After cooling the thus obtained solution to room temperature, 2.5 mL of a 0.6%-by-mass aqueous vanillin solution/phosphoric acid (20/80% by volume) solution was added to each test tube, which was then maintained for 15 minutes at 37° C. This solution was cooled to room temperature, and the absorbance at 540 nm was subsequently measured using Model 680 Microplate Reader (manufactured by Bio-Rad Laboratories, Inc.).

Solutions of known lipid concentrations were measured in advance by the same method as described above to prepare a calibration curve, and the weight of lipids adsorbed to each contact lens was determined from the results of measuring the absorbance.

The test results (comparisons of the amounts of adsorbed lipids) are shown in Table 2. It is noted here that, for Examples 1 to 10 and Comparative Examples 1 and 2, the numerical values shown in Table 2 indicate the values obtained by subtracting the lipid weight of Control 1 from the lipid weight determined in the respective tests and, for Example 11 and 12 and Comparative Example 3, the numerical values shown in Table 2 indicate the values obtained by subtracting the lipid weight of Control 2 from the lipid weight determined in the respective tests.

As shown in Table 2, when those liquid agents containing the present polymer were used (Examples 1 to 12), a prominent lipid adhesion-inhibiting effect was attained.

On the other hand, those liquid agents containing a polymer consisting of only the repeating unit (A) (Comparative Examples 1 to 3) exhibited a low lipid adhesion-inhibiting effect.

### Test Example 5

### Method of Testing Inhibition of PHMB Adsorption

A liquid agent obtained by mixing 0.0001 parts by mass of PHMB and 100.0 parts by mass of physiological saline was used as a control.

To a 50-mL centrifuge tube, 2 mL of each of the liquid agents of Examples 1 to 10, Comparative Examples 1 and 2 and Control 1 was added, and a single silicone hydrogel contact lens (ACUVUE OASYS, manufactured by Johnson & Johnson K.K.) was immersed in this liquid agent, after which the centrifuge tube was left to stand in a 35° C. incubator for 24 hours. Then, the contact lens was taken out. To 1 mL of each liquid agent from which the contact lens had been taken out, 0.2 ml of a 0.003-w/v % acetone solution of fluorescamine was added and, after mixing the resulting mixture for 30 seconds, the fluorescence was measured using a spectrofluorometer FP-6200 manufactured by JASCO Corporation (excitation wavelength: 390 nm, wavelength range: 220 to 730 nm, measurement mode: emission). Further, the fluorescence of each liquid agent was also measured in the same manner, except that no contact lens was immersed therein. Using the same liquid agent, the absorbance was measured for a case where the contact lens was immersed and a case where no contact lens was immersed, and the amount of PHMB adsorbed to the contact lens with the use of each liquid agent was determined from the fluorescence intensity at a wavelength showing the maximum fluorescence intensity. The results thereof are shown in Table 2. It is noted here that the adsorption rates shown in Table 2 were calculated using the following equation.

Adsorption rate (%)=B/A×100

A: Amount of adsorbed PHMB when the liquid agent of Control 1 was used.

B: Amount of adsorbed PHMB when a liquid agent of each test was used.

As shown in Table 2, when those liquid agents containing the present polymer were used (Examples 1 to 10), a clear PHMB adsorption-inhibiting effect was attained.

On the other hand, when those liquid agents containing a polymer consisting of only the repeating unit (A) were used (Comparative Examples 1 and 2), no PHMB adsorption-inhibiting effect was observed.

TABLE 2

| | Examples and Comparative Examples | | | | | | | | | |
|---|---|---|---|---|---|---|---|---|---|---|
| | Example | Example | Example | Example | Example | Example | Example | Example | Example | Example |
| | 1 | 2 | 3 | 4 | 5 | 6 | 7 | 8 | 9 | 10 |
| Polymer name | N-1 | N-2 | N-3 | N-4 | N-5 | N-6 | N-7 | N-8 | N-9 | N-10 |
| Liquid agent | | | | | | | | | | |
| composition | | | | | | | | | | |
| ratio (%) | | | | | | | | | | |
| Polymer | 0.5 | 0.5 | 0.5 | 0.5 | 0.5 | 0.5 | 0.5 | 0.5 | 0.5 | 0.5 |
| PHMB | 0.0001 | 0.0001 | 0.0001 | 0.0001 | 0.0001 | 0.0001 | 0.0001 | 0.0001 | 0.0001 | 0.0001 |
| Benzalkonium | 0 | 0 | 0 | 0 | 0 | 0 | 0 | 0 | 0 | 0 |
| chloride | | | | | | | | | | |
| Physiological | 99.5 | 99.5 | 99.5 | 99.5 | 99.5 | 99.5 | 99.5 | 99.5 | 99.5 | 99.5 |
| saline | | | | | | | | | | |
| Test Example 1: | 0.040 | 0.032 | 0.033 | 0.033 | 0.033 | 0.033 | 0.033 | 0.035 | 0.030 | 0.039 |
| Lipid cleaning | | | | | | | | | | |
| test | | | | | | | | | | |
| Test Example 2: | ⊚ | ⊚ | ⊚ | ⊚ | ⊚ | ⊚ | ⊚ | ⊚ | ⊚ | ⊚ |
| Disinfecting | | | | | | | | | | |
| effect test | | | | | | | | | | |
| Test Example 3: | ◯ | ◯ | ◯ | ◯ | ◯ | ◯ | ◯ | ◯ | ◯ | ◯ |
| Cytotoxlcity | | | | | | | | | | |
| test | | | | | | | | | | |
| Test Example 4: | −9 | −11 | −7 | −10 | −15 | −11 | −8 | −7 | −11 | −13 |
| Lipid stain | | | | | | | | | | |
| Inhibition test | | | | | | | | | | |
| Comparison of | | | | | | | | | | |
| amounts of | | | | | | | | | | |
| adsorbed lipids | | | | | | | | | | |
| (μg) | | | | | | | | | | |
| PHMB | 42 | 38 | 45 | 50 | 48 | 35 | 30 | 56 | 34 | 48 |
| adsorption rate | | | | | | | | | | |
| (%) | | | | | | | | | | |

| | Examples and Comparative Examples | | | | | | |
|---|---|---|---|---|---|---|---|
| | Example | Example | Comparative | Comparative | Comparative | | |
| | 11 | 12 | Example 1 | Example 2 | Example 3 | Control 1 | Control 2 |
| Polymer name | N-1 | N-4 | N-12 | N-13 | N-12 | none | none |
| Liquid agent | | | | | | | |
| composition | | | | | | | |
| ratio (%) | | | | | | | |
| Polymer | 0.5 | 0.5 | 0.5 | 0.5 | 0.5 | 0 | 0 |
| PHMB | 0 | 0 | 0.0001 | 0.0001 | 0 | 0.0001 | 0 |
| Benzalkonium | 0.003 | 0.003 | 0 | 0 | 0.003 | 0 | 0.003 |
| chloride | | | | | | | |
| Physiological | 99.5 | 99.5 | 99.5 | 99.5 | 99.5 | 100.0 | 100.0 |
| saline | | | | | | | |
| Test Example 1: | 0.038 | 0.033 | 0.001 | 0.000 | 0.001 | 0.000 | 0.000 |
| Lipid cleaning | | | | | | | |
| test | | | | | | | |
| Test Example 2: | ⊚ | ⊚ | ⊚ | ⊚ | ⊚ | ⊚ | ⊚ |
| Disinfecting | | | | | | | |
| effect test | | | | | | | |
| Test Example 3: | ◯ | ◯ | Δ | Δ | Δ | Δ | Δ |
| Cytotoxlcity | | | | | | | |
| test | | | | | | | |
| Test Example 4: | −10 | −9 | 0 | 0 | −1 | 0 | 0 |
| Lipid stain | | | | | | | |
| Inhibition test | | | | | | | |
| Comparison of | | | | | | | |
| amounts of | | | | | | | |
| adsorbed lipids | | | | | | | |
| (μg) | | | | | | | |
| PHMB | — | — | 97 | 92 | — | 100 | — |
| adsorption rate | | | | | | | |
| (%) | | | | | | | |

With regard to the above-described embodiments, the following additional notes are further disclosed.

### [Additional Notes]

A bactericidal composition comprising:

a polymer which comprises a repeating unit (A) having an HLB value of 14 or higher and a repeating unit (B) having an HLB value of 1 to less than 14; and

a cationic group-containing bactericidal compound.

A method of producing a composition comprising a polymer and a bactericidal compound, the method comprising the step of:

mixing a polymer, which comprises a repeating unit (A) having an HLB value of 14 or higher and a repeating unit (B) having an HLB value of 1 to less than 14, with a cationic group-containing bactericidal compound.

1. A composition comprising:
a polymer which comprises a repeating unit (A) having an HLB value of 14 or higher and a repeating unit (B) having an HLB value of 1 to less than 14; and
a cationic group-containing bactericidal compound.

2. The composition according to claim 1, wherein the polymer is soluble in water.

3. The composition according to claim 1, wherein the repeating unit (A) comprises a structural unit represented by Formula (1): 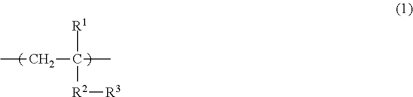
wherein, R¹ represents a hydrogen atom or a methyl group; R² represents —O—, *-(C═O)—O—, *-(C═O)—NR⁴—, or *-NR⁴—(C═O)— where R⁴ represents a hydrogen atom or an organic group having 1 to 10 carbon atoms, and * represents a position at which the group is bound to the carbon atom bound with R¹ in the Formula (1); and R³ represents an organic group having 1 to 100 carbon atoms,
with a proviso that, when R² is *-(C═O)—NR⁴— or *-NR⁴—(C═O)—, R³ and R⁴ may be bound together to form a ring.

4. The composition according to claim 1, wherein the repeating unit (B) comprises a structural unit represented by Formula (2) or (3): 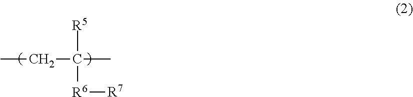
wherein, R⁵ represents a hydrogen atom or a methyl group; R⁶ represents —O—, *-(C═O)—O—, *-(C═O)—NR⁸— or *-NR⁸—(C═O)— where R⁸ represents a hydrogen atom or an organic group having 1 to 10 carbon atoms, and * represents a position at which the group is bound to the carbon atom bound with R⁵ in the Formula (2); and R⁷ represents an organic group having 3 to 100 carbon atoms,
with a proviso that, when R⁶ is *-(C═O)—NR⁸— or *-NR⁸—(C═O)—, R⁷ and R⁸ may be bound together to form a ring; or 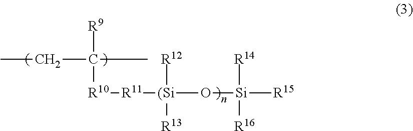
wherein, R⁹ represents a hydrogen atom or a methyl group; R¹⁰ represents —O—, *-(C═O)—O—, *-(C═O)—NR¹⁷—, *-NR¹⁷—(C═O)— where R¹⁷ represents a hydrogen atom or an organic group having 1 to 10 carbon atoms, and * represents a position at which the group is bound to the carbon atom bound with R⁹ in the Formula (3), or a phenylene group; R¹¹ represents a divalent organic group having 1 to 10 carbon atoms; R¹² and R¹³ each independently represent an organic group having 1 to 10 carbon atoms; R¹⁴, R¹⁵ and R¹⁶ each independently represent —OSi(R¹⁸)₃ where each R¹⁸ independently represents a hydrogen atom or an organic group having 1 to 8 carbon atoms, or an organic group having 1 to 10 carbon atoms; and n represents 0 to 200 as an average value.

5. The composition according to claim 1, wherein the repeating unit (A) comprises at least one structural unit selected from the group consisting of a repeating unit (A1) represented by Formula (A1), a repeating unit (A2) represented by Formula (A2), a repeating unit (A3) represented by Formula (A3), a repeating unit (A4) represented by Formula (A4), a repeating unit (A5) represented by Formula (A5), and a repeating unit (A6) represented by Formula (A6): 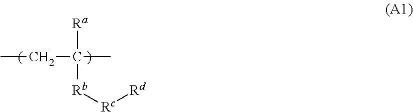
wherein, R^{a} represents a hydrogen atom or a methyl group; R^{b} represents —O—, *-(C═O)—O—, *-(C═O)—NR^{e}—, or *-NR^{e}—(C═O)— where R^{e} represents a hydrogen atom or an organic group having 1 to 10 carbon atoms, and * represents a position at which the group is bound to the carbon atom bound with R^{a} in the Formula (A1); and R^{e} represents a polyoxyalkylene group; and R^{d} represents a hydrogen atom or an alkyl group having 1 to 15 carbon atoms,
with a proviso that a total number of carbon atoms of R^{e} and R^{d} is 100 or less; 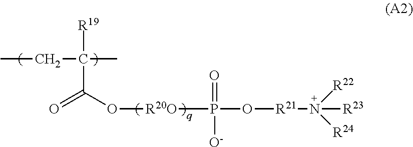
wherein, R¹⁹ represents a hydrogen atom or a methyl group; R²⁰ represents an alkylene group having 2 to 4 carbon atoms; R²¹ represents an alkylene group having 1 to 10 carbon atoms; R²², R²³ and R²⁴ each independently represent a hydrogen atom or a hydrocarbon group having 1 to 8 carbon atoms; and q represents 1 to 10 as an average value; 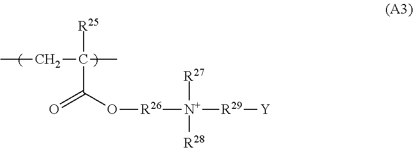
wherein, Y represents —(C═O)O—, —(O═S═O)O⁻, —O(O═S═O)O⁻, —(S═O)O⁻, —O(S═O)O⁻, —OP(═O)(OR³⁰)O⁻, —OP(═O)(R³⁰)O⁻, —P(═O)(OR³⁰)O⁻, or —P(═O)(R³⁰)O⁻ where R³⁰ represents an alkyl group having 1 to 3 carbon atoms; R²⁵ represents a hydrogen atom or a methyl group; R²⁶ represents a divalent organic group having 1 to 10 carbon atoms; R²⁷ and R²⁸ each independently represent a hydrocarbon group having 1 to 10 carbon atoms; and R²⁹ represents a divalent organic group having 1 to 10 carbon atoms; 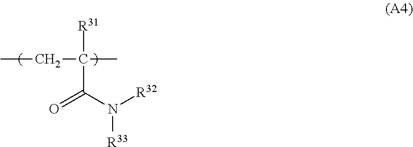
wherein, R³¹ represents a hydrogen atom or a methyl group; R³² and R³³ each independently represent a hydrogen atom, an alkyl group having 1 to 6 carbon atoms, or a hydroxyalkyl group having 1 to 6 carbon atoms; 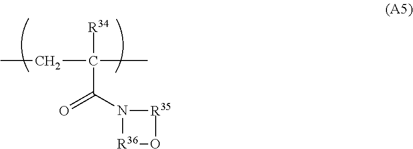
wherein, R³⁴ represents a hydrogen atom or a methyl group; and R³⁵ and R³⁶ each independently represent an alkylene group having 1 to 3 carbon atoms; and 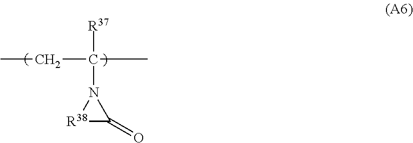
wherein, R³⁷ represents a hydrogen atom or a methyl group; and R³⁸ represents an alkylene group having 1 to 5 carbon atoms.

6. The composition according to claim 1, comprising the polymer in an amount of from 0.001 to 10% by mass.

7. The composition according to claim 1, which is an ophthalmic composition, a cleaning composition, a cosmetic composition, a medical composition, or a quasi drug composition.

8. The composition according to claim 1, which is a contact lens cleaning solution, a contact lens solution, a contact lens fitting liquid, an eye wash, or an eye drop.

9. A contact lens coating agent, comprising a polymer which comprises a repeating unit (A) having an HLB value of 14 or higher and a repeating unit (B) having an HLB value of 1 to less than 14.

10. A method of producing a contact lens, comprising coating a contact lens coating agent according to claim 9, on at least a part of a surface of a contact lens.

11. A contact lens comprising, on at least a part of a surface thereof, a contact lens coating agent according to claim 9.

12. A silicone hydrogel contact lens comprising, on at least a part of a surface thereof, a contact lens coating agent according to claim 9.
